(19) United States
(12) Patent Application Publication
(10) Pub. No.: US 2025/0076527 A1
(43) Pub. Date: Mar. 6, 2025

(54) METHOD TO CORRECT ERRONEOUS LOCAL TRAVELTIME OPERATORS

(71) Applicant: SAUDI ARABIAN OIL COMPANY, Dhahran (SA)

(72) Inventor: Yimin Sun, Den Haag (NL)

(73) Assignee: ARAMCO OVERSEAS COMPANY B.V., The Hague (NL)

(21) Appl. No.: 18/457,286

(22) Filed: Aug. 28, 2023

(51) Int. Cl. G01V 1/30; E21B 44/00; E21B 49/00; G01V 1/34

(52) U.S. Cl. CPC G01V 1/30; E21B 7/04; E21B 44/00; E21B 49/00; G01V 1/282; G01V 1/305; G01V 1/345; G01V 2210/66

(57) ABSTRACT

Methods and systems are disclosed. The methods may include obtaining a seismic dataset with a plurality of dimensions pertaining to a subterranean region of interest and forming a plurality of spatial nodes within the seismic dataset. The method may further include determining, for each node, a traveltime operator, based on a portion of the seismic dataset within an aperture surrounding the node, assigning a canonical operator based on the traveltime operator, and forming a plurality of windows containing a neighboring node. For each window, the method may include determining a modal canonical operator, based on the canonical operator for each neighboring node, determining modal-nodes and deviating-nodes within the window, and determining a replacement traveltime operator for each deviating-node. The method may still further include forming a seismic image based on the seismic dataset, the traveltime operator of the modal-nodes, and the replacement traveltime operator of the deviating-nodes.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series of samples recorded at many receiver locations generated by a seismic source at many source locations constitutes a seismic dataset.

To determine the earth structure, including the presence of hydrocarbons, the seismic dataset may be processed. Processing a seismic dataset includes a sequence of steps designed to correct for a number of issues, such as near-surface effects, noise, and irregularities in the seismic survey geometry, etc. In another step in processing a seismic dataset a seismic velocity model may be determined representing the speed at which seismic waves propagate at various points within subsurface. The seismic dataset and the seismic velocity model may be combined using a process called “migration” to form a seismic image of the subsurface. Typically, such a seismic image displays points of high and low seismic reflection amplitude on a color scale or grayscale on a dense two-dimensional (2D) or three-dimensional (3D) grid of points representing the subsurface below the seismic survey area. Such a seismic image may then be interpreted, together with other information, to determine geological structures that may contain hydrocarbons extractable with a wellbore drilled from the surface.

Many steps in seismic processing, including velocity analysis and migration require the combination of seismic samples generated by seismic sources located at a plurality of spatial positions on the surface and recorded by seismic receivers located at a plurality of spatial positions. The correct combination of these samples requires the determination and use of moveout curves or traveltime operators that determine which time sample or samples from each spatial position to combine. These traveltime operators may be estimated but the presence of noise in the seismic dataset may make this process prone to error and require extensive manual quality control.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to method. The method includes obtaining, from a seismic acquisition system, a seismic dataset pertaining to a subterranean region of interest, wherein the seismic dataset includes a plurality of samples in a plurality of dimensions. The method further includes, using a seismic processing system, forming a plurality of nodes, where each node of the plurality specifies a location in the plurality of dimensions and wherein each node has a plurality of neighboring nodes adjacent to it in the plurality of dimensions, and for each node, determining a traveltime operator, based on a portion of the seismic dataset within an aperture surrounding the node, and assigning a canonical operator based on the traveltime operator. The method further includes forming a plurality of windows, wherein each window of the plurality of windows includes a neighboring node, and for each window of the plurality of window, determining a modal canonical operator, based on the canonical operator for each neighboring node within the window, determining modal-nodes within the window, wherein the canonical operator of each modal-node is equal to modal canonical operator, determining deviating-nodes within the window, wherein the canonical operator of each deviating-node deviates from the modal canonical operator, and determining a replacement traveltime operator for each deviating-node based on the traveltime operator of modal-nodes within the window. The method still further includes forming a seismic image of the subterranean region of interest based on the seismic dataset and the traveltime operator of the modal-nodes within the plurality of nodes and the replacement traveltime operator of the deviating-nodes within the plurality of nodes.

In general, in one aspect, embodiments relate to a system, including a seismic acquisition system, and a seismic processing system. The seismic acquisition system is configured to obtain a seismic dataset pertaining to a subterranean region of interest, wherein the seismic dataset includes a plurality of samples in a plurality of dimensions. The seismic processing system is configured to form a plurality of nodes, where each node of the plurality specifies a location in the plurality of dimensions and wherein each node has a plurality of neighboring nodes adjacent to it in the plurality of dimensions, and for each node, determine a traveltime operator, based on a portion of the seismic dataset within an aperture surrounding the node, and assign a canonical operator based on the traveltime operator. The seismic processing system is further configured to form a plurality of windows, wherein each window of the plurality of windows includes a neighboring node, and for each window of the plurality of window, determine a modal canonical operator, based on the canonical operator for each neighboring node within the window, determine modal-nodes within the window, where the canonical operator of each modal-node is equal to modal canonical operator, determine deviating-nodes within the window, where the canonical operator of each deviating-node deviates from the modal canonical operator, and determine a replacement traveltime operator for each deviating-node based on the traveltime operator of modal-nodes within the window. The seismic processing system is still further configured to form a seismic image of the subterranean region of interest based on the seismic dataset and the traveltime operator of the modal-nodes within the plurality of nodes and the replacement traveltime operator of the deviating-nodes within the plurality of nodes.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIG. 1 shows a flowchart in accordance with one or more embodiments;

FIG. 2 depicts a seismic acquisition system in accordance with one or more embodiments;

FIG. 3 depicts seismic gathers in accordance with one or more embodiments;

FIG. 4 shows a portion of a seismic dataset and traveltime operators in accordance with one or more embodiments;

FIG. 5 depicts seismic gathers in accordance with one or more embodiments;

FIG. 6A depicts two-dimensional canonical moveout curves in accordance with one or more embodiments;

FIG. 6B depicts three-dimensional canonical moveout surfaces in accordance with one or more embodiments;

FIG. 7A depicts convex and non-conflex sets in accordance with one or more embodiments;

FIG. 7B illustrates projection onto convex sets in accordance with one or more embodiments;

FIGS. 8A-8F show traveltime operators in accordance with one or more embodiments;

FIG. 9 shows a flowchart in accordance with one or more embodiments;

FIG. 10 depicts a drilling system in accordance with one or more embodiments; and

FIG. 11 depicts a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

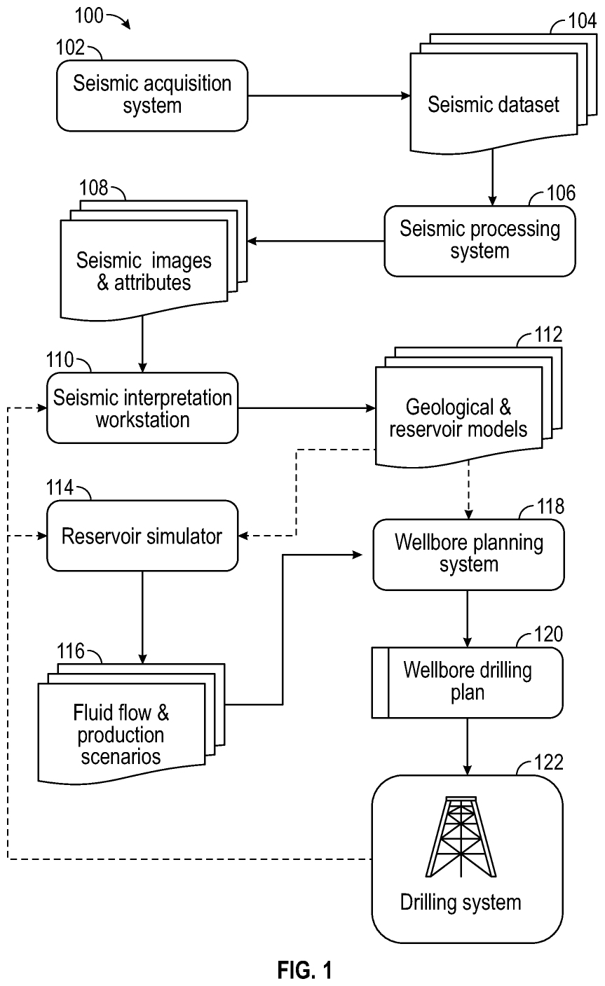

In the following description of FIGS. 1-11, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a traveltime operator” includes reference to one or more of such traveltime operators.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Seismic traveltime operators are used in many applications of seismic data processing, such as velocity analysis and migration, to permit the combination of samples collected at different spatial locations. Estimating these traveltime operators is frequently hindered by noise in the seismic data, leading to erroneous outlier estimates. Methods and systems are provided for identifying these erroneous outliers and correcting or replacing them based on accurate estimate at spatially neighboring locations.

FIG. 1 depicts a flowchart (100) in accordance with one or more embodiments. FIG. 1 illustrates the steps of acquiring remote sensing data, processing the remote sensing data, forming a geological model, optionally simulating the flow of fluids, including hydrocarbons, though the geological model, the planning of wellbores including their surface position, trajectories, and targets, and the drilling of those wellbores. Although the steps in flowchart (100) are shown in sequential order, it will be apparent to one of ordinary skill in the art, that some steps may be conducted in parallel, or in a different order than shown, or may be omitted without departing form the scope of the invention.

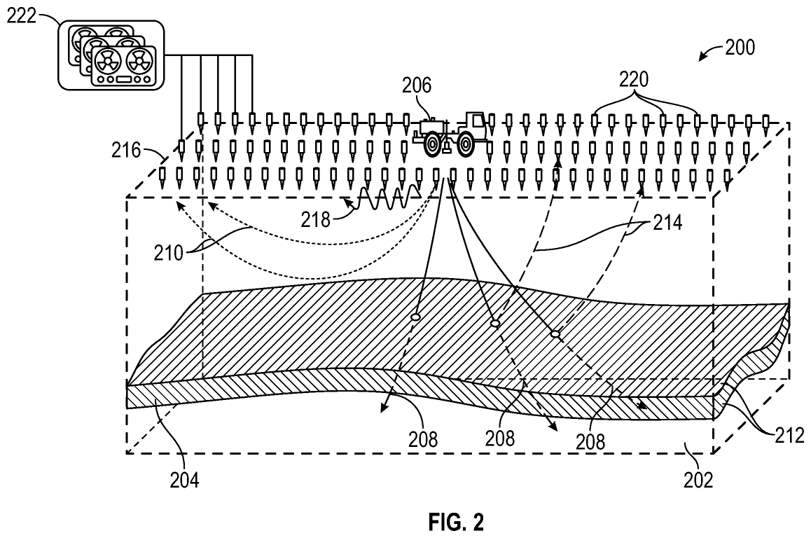

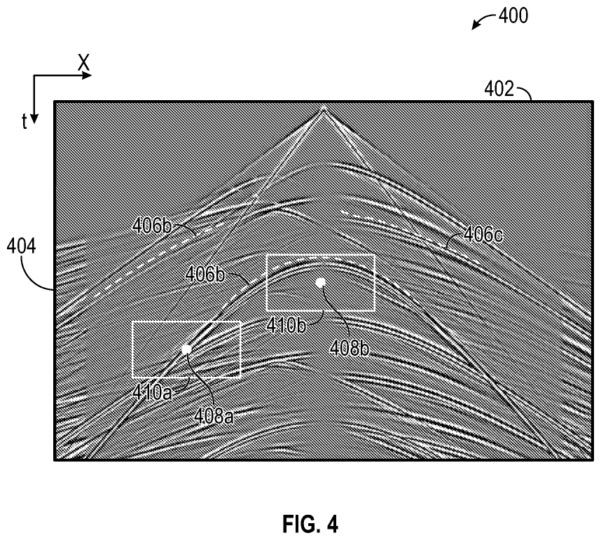

For example, flowchart (100) may begin with the use of a seismic acquisition system (102) to acquire a seismic dataset (104) over a subterranean region of interest. The seismic acquisition system (102) will be described in more detail in the context of FIG. 2, and an example of a seismic dataset is shown in FIG. 4. Other remote sensing datasets may also be collected at this stage to characterize the subterranean region of interest. For example, resistivity, transient electromagnetic, and/or gravitation surveys may be collected.

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors” in two-dimensional (“2D”) or three-dimensional (“3D”) space within the subterranean region.

To determine earth structure, including the presence of hydrocarbons, the seismic data set must be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Each of these steps may be accompanied by one or more quality control steps. Critical steps in processing seismic data include beam forming and seismic migration. Seismic migration is a process by which seismic events are re-located in either space or time to their true subsurface positions.

It will be appreciated by one of ordinary skill in the art that seismic datasets (104) are extremely large, typically occupying hundreds of Terabytes or more than a Petabyte in size, (corresponding to between 10 trillion (1013) and 100 trillion (1014) data samples) and cannot be manipulated or “processed” without the assistance of a purpose configured seismic processing system (106).

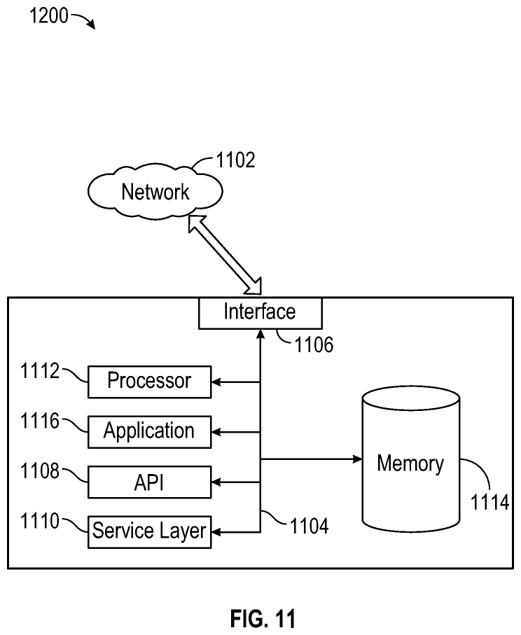

A seismic processing system (106) may be composed of a computer system, such as the computer system shown in FIG. 11. However, a seismic processing system will typically be configured with appropriate seismic processing software and augmented with a number of purpose specific elements, such as high capacity tape drives or hard drives connected through high-speed buses to computer processing units (“CPUs”). Further the CPUs of a seismic processing system will typically be connected to a plurality of graphical processing units (“GPUs”) that perform many of the computationally intensive operations on the seismic dataset (104), banks of high-speed tape, or hard-drive, readers to read the data from storage, high-speed tape or hard-drive writers to output final or intermediate results, and high-speed communication buses to connect these elements.

The result of processing a seismic dataset (104) with a seismic processing system (106) is a seismic image (108). The seismic image is a 2D or 3D image of the points within the subsurface that generate a distinctive seismic response. For example, the seismic image (108) may display the points at which seismic energy is reflected, or scattered, within the subsurface. Other seismic characteristic or “attributes” of the subsurface may be displayed as a seismic image (108). For example, the strength of conversion of energy from one type of seismic wave to another, or the strength of absorption of seismic energy, or the velocity of seismic propagation may be displayed as a function of subsurface position in the seismic image (108). The examples of seismic attributes given above are purely illustrative, and a person of ordinary skill in the art will appreciate that anyone of dozens of other attributes may be displayed as a seismic image (108) and the examples described should not be interpreted as limiting the scope of the invention in any way.

The seismic image (108) is an image, typically composed of pixels of varying intensity, and is not itself a model of the geological structure of the subterranean region to which it pertains. To determine the geological structure corresponding to, or that produced, the seismic image (108) the seismic image (108) is typically “interpreted” using a seismic interpretation workstation (110).

A seismic interpretation system (110) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs. Additional data may be used within the seismic interpretation workstation (110) to facilitate the interpretation of the seismic dataset. Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

Interpreters may pick and interpret key geological horizons within seismic data to identify stratigraphic layers, boundaries, and structural features. Horizon interpretation tools and workflows allow for the accurate extraction of geological information from seismic volumes. For example, a seismic interpretation system (110) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (110) to build 3D geological models by integrating seismic data with well-log data, geological knowledge, and other geophysical information. These models help in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (110) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

The seismic interpretation system (110) are essential tools for geoscientists involved in exploration and production activities, helping them make informed decisions about drilling locations, optimize production strategies, and understand complex subsurface geological structures. The seismic interpretation system (110) may be a specialized computer system used by geoscientists and seismic interpreters for analyzing and interpreting seismic data.

Seismic interpretation involves intensive tasks like data visualization, horizon picking, attribute analysis, and 3D modeling. A high-performance seismic interpretation system (110) with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (110) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (110) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. A seismic interpretation workstation (110) may be augmented with purpose specific peripherals such as high capability display devices that may include immersive or virtual reality devices, such as virtual-reality headsets or immersive “caves”. Additionally, color-calibrated and high-accuracy input devices enhance the precision of interpretation tasks like picking horizons or drawing geological features. The seismic interpretation system (110) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (110) or collaborate with colleagues remotely. Setting up remote access capabilities, such as Virtual Private Networks (VPNs) or remote desktop solutions, allows interpreters to work from different locations and share their work effectively. The seismic interpretation system (110) may be customized to meet the needs of interpreters and the specific requirements of projects. The hardware specifications may vary based on factors like the complexity of interpretations, the size of datasets, and the software tools utilized.

The result of interpreting the seismic image may be a geological model (112) of the subsurface, including reservoir models of hydrocarbon reservoirs within the subterranean region of interest. Geological models (112) may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system (118). Such a wellbore drilling plan (120) may contain drilling targets, often geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system. Similarly, the wellbore drilling plan (120) may include a determination of wellbore caliper, and casing points.

The wellbore planning system (118) may include dedicated software stored on a memory of a computer system, such as the computer system shown in FIG. 11. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

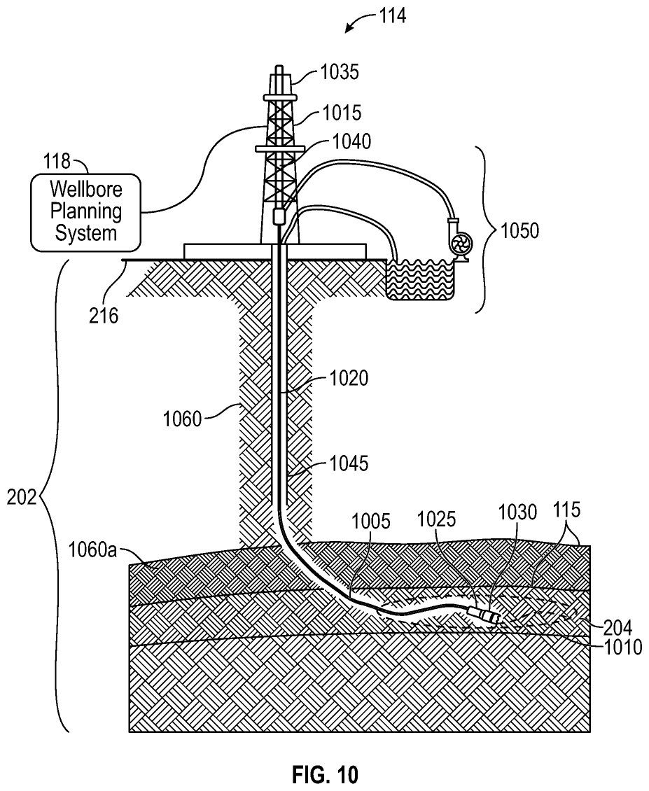

The wellbore path, such as the wellbore path (1004) shown in FIG. 10, may include a starting surface location of the wellbore, or a subsurface location within an existing wellbore, from which the wellbore (1002) may be drilled. The wellbore path (1004) may further include a terminal location that may intersect with the previously located hydrocarbon reservoir, such as hydrocarbon reservoir (204) shown in FIG. 2. The wellbore path (1004) may further still include wellbore geometry information such as wellbore diameter and inclination angle and when each of these change along the depth of the wellbore. If casing is used, the wellbore plan (120) may include casing type or casing depths. Furthermore, the wellbore plan (120) may consider other engineering constraints such as the maximum wellbore curvature (“dog-log”) that a drillstring of a drilling system may tolerate and the maximum torque and drag values that the drilling system may provide. The wellbore plan (120) may further define associated drilling parameters, such as the planned depths at which drilling may be paused and casing will be inserted to support the wellbore (1002) to prevent formation fluids entering the wellbore (1002) and the drilling mud weights (densities) and types that may be used during drilling of the wellbore (1002).

In some embodiments, the geological model (112) may be input to a reservoir simulator (114). A reservoir simulator (114) includes functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into wells penetrating the reservoir as a result of planned well drilling, and/or fluid injection and extraction. For example, the reservoir simulator may be used to predict fluid-flow and production scenarios (116) including changes in hydrocarbon production rate that would result from the injection of water into the reservoir from wells around the reservoirs periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected from well logs acquired in well penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators solve a set of mathematical governing equations that represent the physical laws that govern fluid flow in porous, permeable media. For example, the flow of a single-phase slightly compressible oil with a constant viscosity and compressibility the equations capture Darcy's law, the continuity condition and the equation of state.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The fluid flow and production scenarios (116) predicted by the reservoir simulator (114) may then be used by the wellbore planning system (118) to determine the wellbore drilling plan (120).

While a wellbore drilling plan (120) is formed using the best available information at the time at which it is formed, additional information may become available when drilling the wellbore specified by the plan. For example, well logs providing new information about the reservoir structure and characteristic may be acquired while drilling (so-called “logging-while-drilling” (LWD) logs or during drilling pauses in, or at the completion of drilling of, a wellbore specified by the drilling plan (120). These well logs acquired during pauses or at the cessation of drilling may be acquired using wireline or coiled tubing conveyed logging tools. However acquired, these new wells may be used to update geological and reservoir models (112) with the aid of a seismic interpretation workstation or to directly update the reservoir simulation performed by the reservoir simulator (114).

FIG. 2A shows a seismic acquisition system (200) configured to acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region (202) and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receiver (220) may be positioned at a seismic receiver location that may be denoted (xᵣ, yᵣ) where x and y represent orthogonal axes, such as North-South and East-West, on the surface of the earth (216) above the subterranean region of interest (202). Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey. Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other cases, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume (four space dimensions and one time dimension) with coordinate axes (xᵣ, yᵣ, yₛ, yₛ, t).

Displaying, processing, and interpreting a five dimensional volume may be challenging.

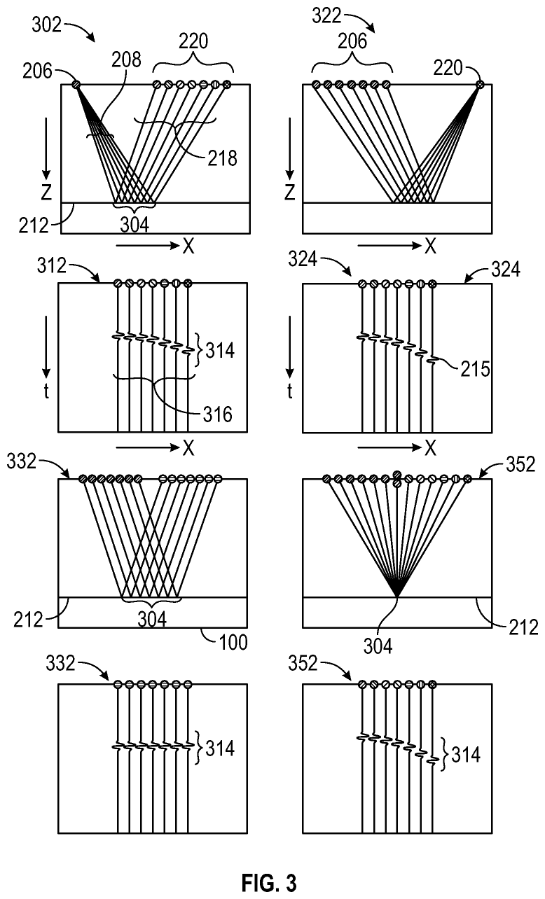

Consequently, a number of ways of arranging seismic dataset are in widespread use. FIG. 3 illustrates some of these methods of arrangement. Diagram (302) illustrates the spatial geometry of a common-source gather. In diagram (302) the horizontal axis represents location in a horizontal plane of a seismic source (206) and a plurality of seismic receivers (220). The vertical axis represents depth below the surface of the earth (216). Rays emanating from the seismic source (206), reflection from a geological boundary (212) and propagating as reflected seismic waves (214) indicate the path of seismic waves schematically.

This common-source gathers correspond to the physical acquisition of a typical seismic dataset with the seismic waves generated by a single activation of a seismic source (206) being recorded by a plurality of seismic receivers (220). Diagram (312) depicts the recorded seismic data. In diagram (312) the horizontal axis indicates the spatial location of the seismic receivers (220) and the vertical axis indicates time, specifically recording time elapsed after a reference time, such as the time of activation of the seismic source (206). However, from the perspective of processing the seismic dataset common-source gathers suffer from the fact that the reflection points (304) on the geological boundary (212) vary from one receiver to another and the time at which the reflected energy (314) is recorded on each receiver recording “trace” (316) varies from one trace to another.

Recorded seismic dataset may frequently be reorganized into common-receiver gathers, such as the common-receiver gather geometry (322) and common-receiver gather traces (324). A common-receiver gather (322) shows the data recorded by a single seismic receiver (220) from a plurality of seismic source (206) activation locations. However, from the perspective of processing the seismic dataset common-receiver gathers suffer from shortcomings similar to those of common-source gathers.

A common-offset gather presents data collected when the seismic source (206) location and the seismic receiver (220) locations are at a constant separation (or “offset”) from one another. The geometry of a common-offset gather is displayed schematically in diagram (332) and the recorded traces in diagram (332). In common-offset gathers while the time at which the reflected energy (314) is recorded on each receiver trace is constant the reflection points (304) on the geological boundary (212) still varies from one receiver to another.

Common-source and common-receiver gathers are typically used as basic quality assessment tools in field acquisition. Common-offset gathers typically used for basic quality control, because they display an approximation to the geological structure over a vertical slice through the subsurface.

Finally, diagrams (352) and (362) illustrate the geometry and recorded data for a common-midpoint gather respectively. A common-midpoint gather displays traces recorded by seismic sources and seismic receivers arrange with a single (“common”) midpoint but varying offset. In many cases common-midpoint gathers are preferred because each trace shares (approximately) the same reflection point (314) on the geological boundary (212). Consequently, each trace in the common-midpoint gather contains information about the same point. However, because of the varying offset between seismic source and seismic receiver pairs the time at which the reflected energy (314) is recorded on each receiver trace varies. Correctly, combining the traces requires estimating the variation in the time at which the reflected energy (314) is received with offset, i.e., estimating a traveltime operator, and correcting for it in processing.

FIG. 4 shows a simulated common-midpoint gather (400) without noise. Although the simulated common-midpoint gather (400). Seismic source-seismic receiver offset is indicated on the horizontal axis (402) while traveltime is indicated on the vertical axis (404). FIG. 4 also illustrates three traveltime operators (406a-406b), and two nodes (408a-408b) together with their apertures (410a-410b) in accordance with one or more operators.

Traveltime operators describe wavefronts and may be defined by:

$$Δ t ( x , y , {x}_{0} , {y}_{0} ) = t ( x , y ) - t ( {x}_{0} , {y}_{0} ) \qquad Eq . ( 1 )$$

where t(x,y) represent a traveltime at a point with coordinates (x,y) and t(x₀,y₀) represent the traveltime at a reference point or node with coordinates (x₀,y₀). The traveltime operator may be approximated by the second-order (quadratic) expression:

$$Δ t ( x , y , {x}_{0} , {y}_{0} ) = A \cdot ( x - {x}_{0} ) + B \cdot ( y - {y}_{0} ) + C \cdot ( x - {x}_{0} ) ( y - {y}_{0} ) + D \cdot {( x - {x}_{0} )}^{2} + E \cdot {( y - {y}_{0} )}^{2} \qquad Eq . ( 2 )$$

where A, B, C, D, and E are coefficients that may be estimated from the data.

Traveltime operators may be estimated from input seismic data in a purely data-driven manner. The unknown coefficients {A, B, C, D, E} may be determined finding the extremum of a cost-function. For example, the unknown coefficients may be determined by maximizing a semblance-type cost function:

$$S ( {x}_{0} , {y}_{0} ) = \frac{{\sum }_{j = 1}^{N} {\{ {\sum }_{i = 1}^{M} u [ {x}_{i} , {y}_{i} ; {t}_{j} ( {x}_{0} , {y}_{0} ) + Δ t ( {x}_{i} , {y}_{i} ; {x}_{0} , {y}_{0} ) ] \}}^{2}}{M {\sum }_{j = 1}^{N} {\sum }_{i = 1}^{M} {\{ u [ {x}_{i} , {y}_{i} ; {t}_{j} ( {x}_{0} , {y}_{0} ) + Δ t ( {x}_{i} , {y}_{i} ; {x}_{0} , {y}_{0} ) ] \}}^{2}} \qquad Eq . ( 3 )$$

where u[xᵢ,yᵢ;tⱼ(x₀,y₀)] represents the value of sample at time tⱼ of the at the location xᵢ,yᵢ. M is the total number of traces within the spatial aperture surrounding the node, and N is the total number of time samples within the temporal aperture surrounding the node. Eq. (3) may be highly nonlinear, and it typically requires efficient nonlinear solvers to effectively estimate traveltime operators.

Since traveltime operators may be estimated in a data-driven manner, the quality of the estimation may depend heavily on the quality of input seismic data. However, seismic datasets typically contain seismic noise, defined as any unwanted recorded energy that is present in a seismic data set. Seismic noise may be random or coherent. For example, seismic noise may include, without limitation, swell, wind, traffic, seismic interference, mud roll, ground roll, and multiples. If the input seismic dataset is too noisy, or spatially sampling too sparse, the estimate traveltime operators may themselves be noisy, i.e., contain many erroneous outliers, and applications relying on accurately estimated traveltime operators, such as the nonlinear beamforming, will themselves be degraded.

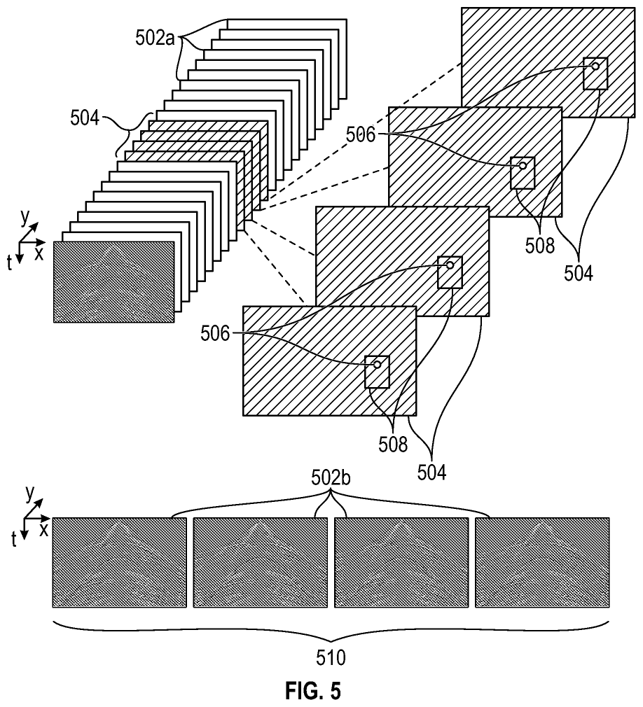

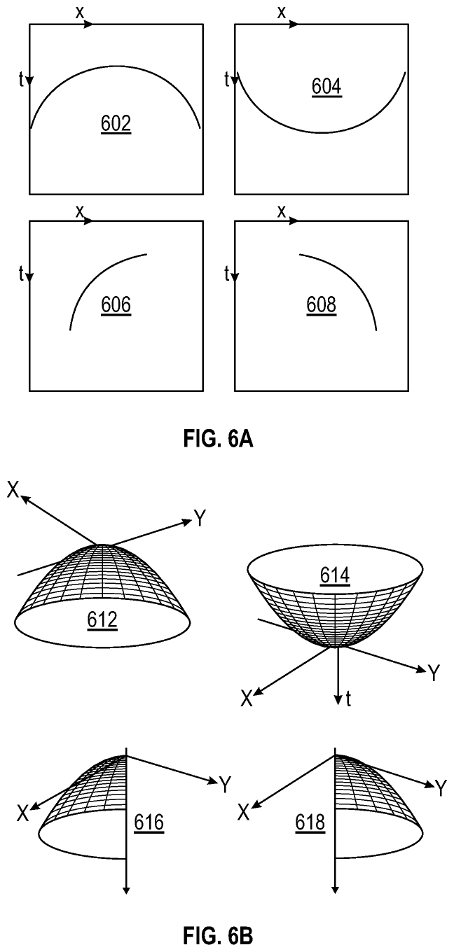

In accordance with one or more embodiments, erroneous outliers may be eliminated in traveltime operators by comparing an estimated traveltime operator for a node with the estimated traveltime operator for neighboring nodes. FIGS. 5 and 6 illustrate this procedure.

FIG. 5 illustrates a plurality of seismic gathers (502a, 502b) in accordance with one or more embodiments. For example, the seismic gathers (502a, 502b) may be common-midpoint gathers. In some embodiments, the seismic gathers may be two-dimensional (2D) gathers, as illustrated in FIG. 5, while in other embodiments the seismic gathers may be three-dimensional (3D). A plurality of neighboring gathers may be selected to form a window (504), with each containing a neighboring node (506) and corresponding aperture (508), defined by M and Nin Eq. (3), over which the traveltime operator may be calculated.

As illustrated in FIG. 5, in some embodiments the traveltime operator may be calculated in the plane designated x-t and neighboring nodes (506) selected to form a window (504) along the y-axis. In other embodiments, the neighboring nodes (506) may be selected from a window from midpoint-gathers along the x-axis, such as the window (510). In still other embodiments, the window may have a finite extent along both the x-axis and the y-axis.

Once a traveltime operator has been calculated for a plurality of neighboring nodes, the traveltime operators may be categorized by assigning each to one of a set of canonical operators, such as the canonical operators shown in FIGS. 6A and 6B. FIG. 6A shows a set of canonical operators in 2D. In canonical operator (602) the traveltime, indicated on the vertical axis, increases at both extremes of the spatial axis, indicated on the horizontal axis) within the aperture compared to the traveltime at an intermediate position between the spatial extremes (a “frown”). In contrast, in canonical operator (604) the traveltime decreases at both extremes of the spatial axis (a “smile”). Similarly, in canonical operator (606), the traveltime increases monotonically from the left of the spatial axis to the right, and in canonical operator (608), the traveltime increases monotonically from the right of the spatial axis to the left. In each of the canonical operators, the absolute size of the traveltime changes is not significant. Rather, the relative difference between traveltimes at different points along the spatial axis defines the canonical operator.

Similarly, in accordance with some embodiments, FIG. 6B illustrate canonical operators in 3D with canonical operator (612) being the 3D analogue of canonical operator (602) in 2D, and canonical operator (614) being the 3D analogue of canonical operator (604) in 2D. Likewise canonical operator (616) may be considered as analogous to canonical operator (606), and canonical operator (618) may be considered as analogous to canonical operator (608). Only a subset of the possible canonical operators that may be defined by a person of ordinary skill in the art are illustrated in FIGS. 6A and 6B, and the illustrated canonical operators are not intended to be limiting to the scope of the invention.

A canonical operator for each neighboring node in the window may be determined by comparing the traveltime operator for each node to the set of canonical operators, such as those shown in FIG. 6A or FIG. 6B and assigning to each node the canonical operator that is most similar to the traveltime operator of the node.

Once a canonical operator has been determined a modal canonical operator may be found by determining which is the most common canonical operator within the window of adjacent nodes. For example, if in a window of 100 adjacent nodes, there are 50 nodes to which the canonical operator (602) has been assigned, 25 nodes to which the canonical operator (606) has been assigned, 15 nodes to which the canonical operator (608) has been assigned, and 10 nodes to which the canonical operator (602) has been assigned, then the modal canonical operator will be determined to be canonical operator (602).

Nodes with canonical operator equal to the modal canonical operator are referred to herein as “modal nodes,” while nodes with canonical operator not equal to the modal canonical operator are referred to herein as “deviating nodes.” In the next step of the workflow, the traveltime operator for each deviating node may be replaced by a new traveltime operator, referred to herein as a “replacement traveltime operator” based upon the traveltime operator of at least a portion of the modal nodes. For example, the replacement traveltime operator may be determined based on interpolation between, or extrapolation from, the traveltime operator of at least a portion of the modal nodes. In some embodiments, the interpolation may use piecewise constant interpolation, linear interpolation, polynomial interpolation, spline interpolation, mimetic interpolation, function approximation, Gaussian process interpolation, multivariate interpolation or any other form of interpolation or extrapolation known in the art. In particular, the replacement traveltime operator may be determined based on performing convergent projection onto convex sets.

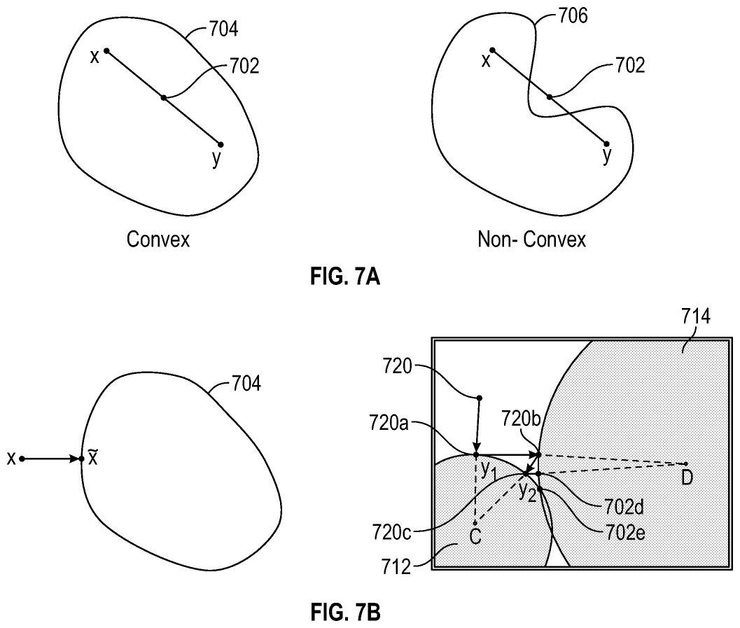

To illustrate the principle of convex sets, we use a simple 2D vector space as it allows easy illustration. Geometrically, a set A is convex if for any two vectors x∈A and y∈A, then λx+(1−λ)y∈A, for any scalar 0≤λ≤1, i.e., any vector on a line between two vectors in the set is also in the set. This may illustrate visually in FIG. 7A where the intermediate vector (702) lies within the convex set (704), but the intermediate vector (702) lies without the non-convex set (706).

In signal reconstruction, the same principle may be applied to signals in a signal space, defined as all signals with finite energy. It contains higher-order convex sets and subspaces that can be visualized as hyper volumes. Signals that form convex sets are usually geometrically related. For example, bounded signals, signals with identical middles, signals with a constant area, band-limited signals, or signals with a constant phase.

The concept of signal projection is explained using the vector analogy once more. Given a vector x within the convex set A, its projection onto A is just itself, i.e., the projection of x, \tilde{x}=x. However, if x is not within the convex set A, then its projection, \tilde{x}, onto A must satisfy all the desired constraints of A. Geometrically, the projection is performed such that the distance between x and its projection \tilde{x} is minimized as shown in FIG. 7B. The projection is typically obtained by forcing the signal to conform to the constraint in the simplest way. This concept is easily scalable to higher dimensions in the signal space.

For two or more convex sets, alternating the projections between these sets to a convergent point (“CPOCS”) aims to reconstruct a signal conforming to all the constraints of these convex sets. However, the convergence outcome depends on how the convex sets intersect. If the convex sets intersect in a single point, the alternating projections will converge to a unique solution. If the intersection area is more than a point—a line, a hyperplane, or a hypersphere volume in general—the solution is non-unique. The solution then depends on the starting point.

An example of CPOCS for two convex sets (712, 714) is shown in FIG. 7B. A vector (720) lying outside both convex sets (712, 714) may first be projected onto convex set (712) to form a vector (720a) from where vector (720a) is projected onto convex set (714) to form a vector (720b). Similarly, vector (720b) is projected onto convex set (712) to form a vector (720c) and then vector (720c) is projected onto convex set (714) to form a vector (720d). This alternating projection process continues until the intersection of convex sets (712, 714) is reached with the vector (720e).

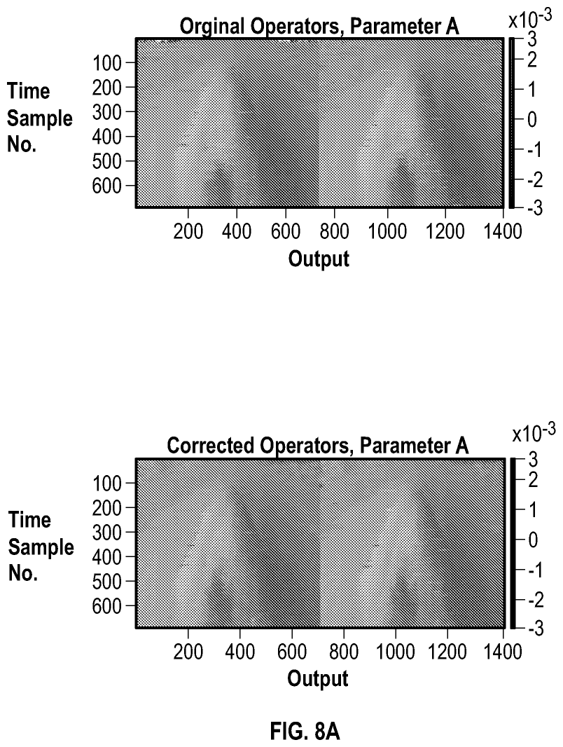

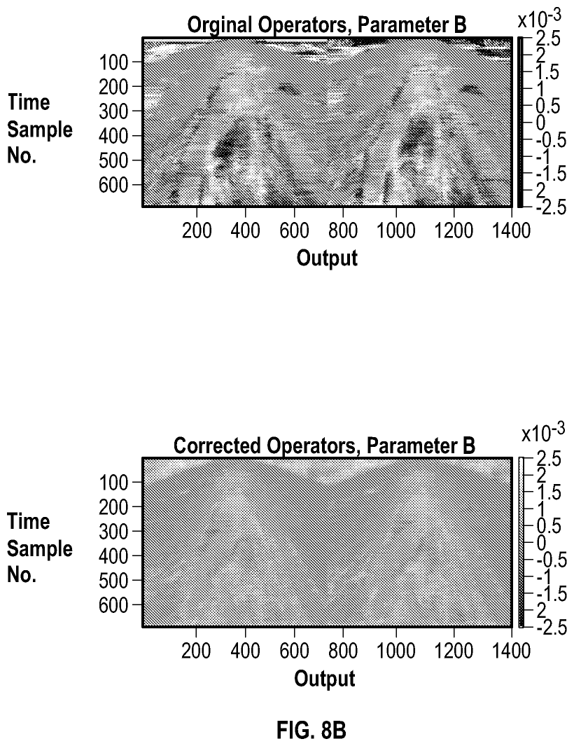

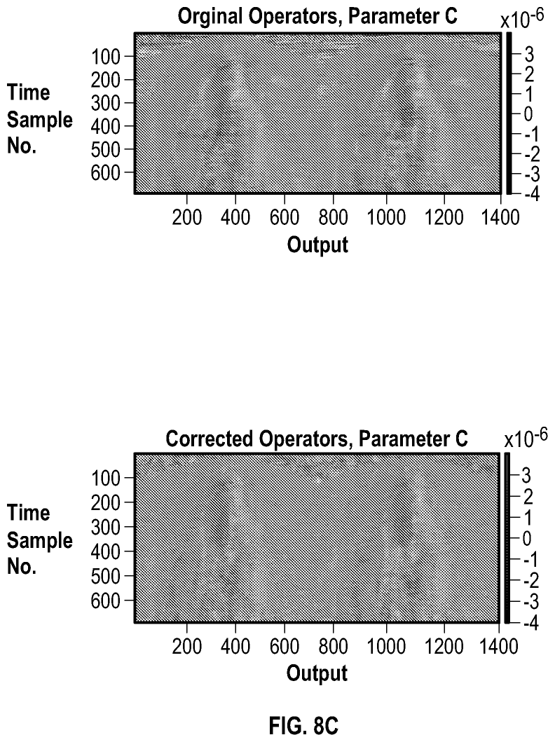

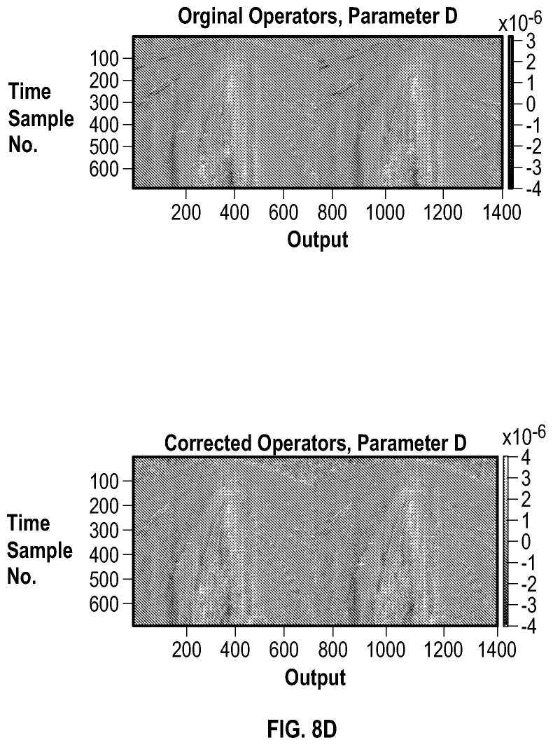

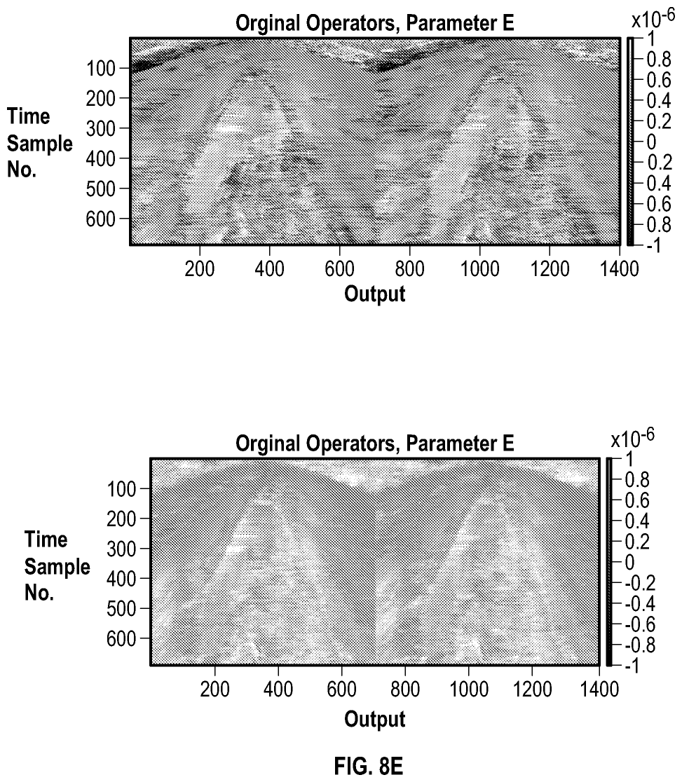

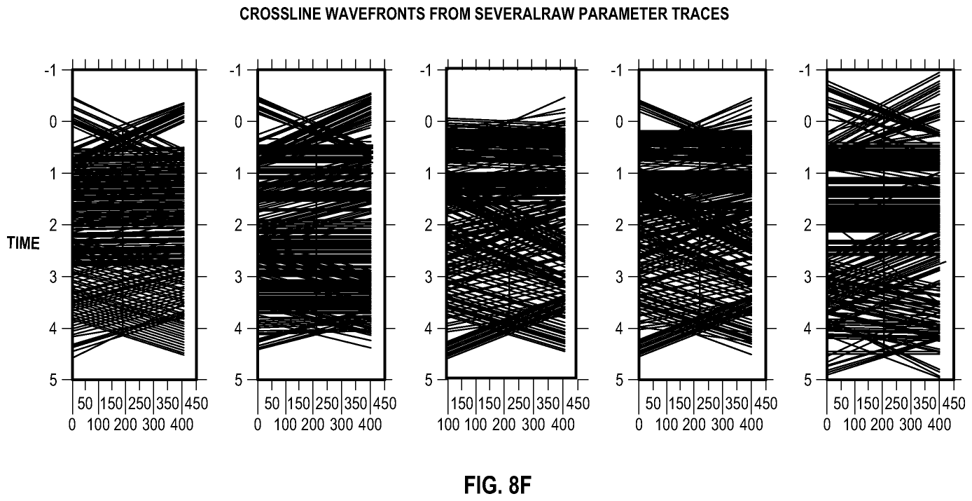

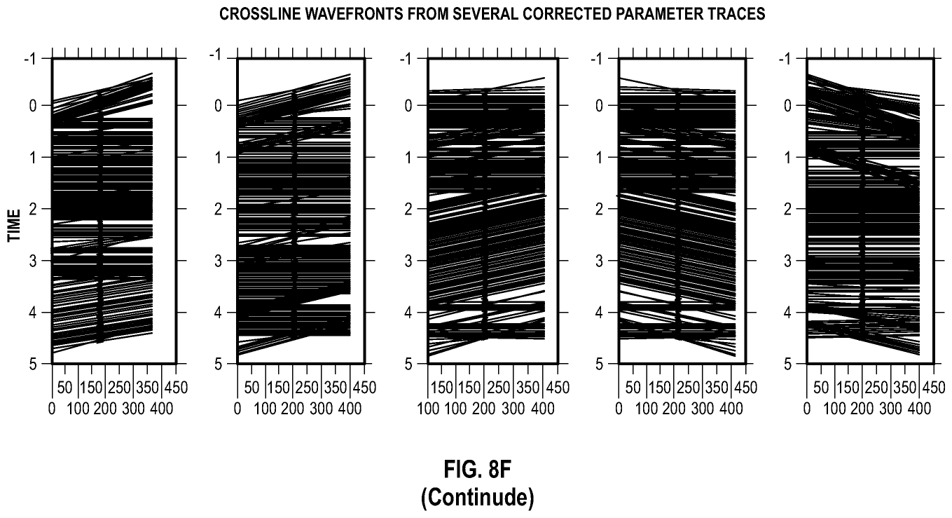

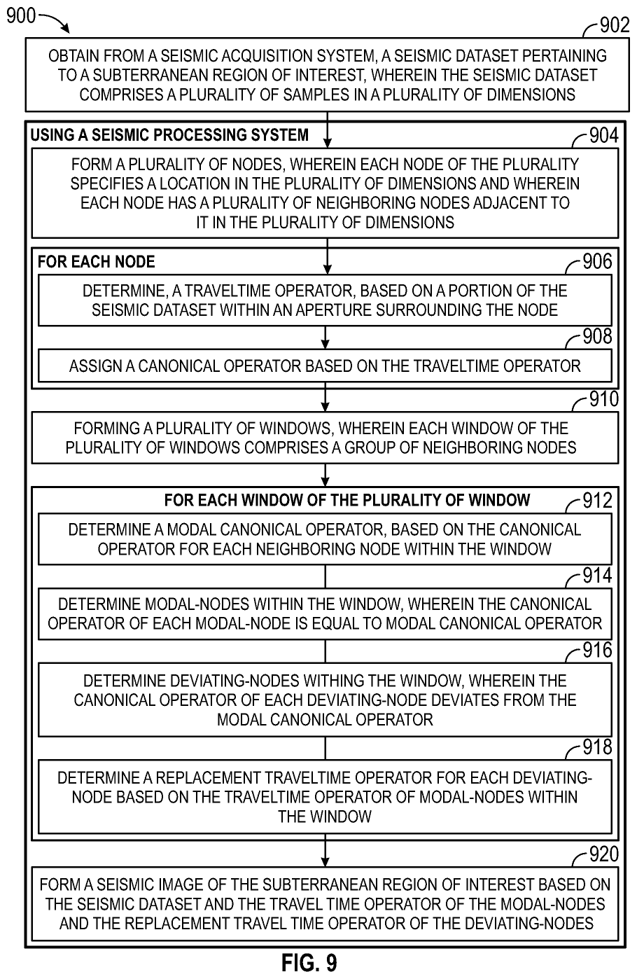

FIGS. 8A-8F show examples of traveltime operators before and after the application of the embodiments disclosed herein. In each of FIGS. 8A-8F, the upper panel shows the traveltime operators input into the workflow described above and in FIG. 9. In contrast, the lower panel in each of FIGS. 8A-8F shows the output of the workflow, including the traveltime operators of the modal nodes and the replacement traveltime operators for the deviating nodes. The vertical axes in both the upper and lower panels of FIGS. 8A-8E indicate traveltime while the horizontal axes indicate spatial position. In each of FIGS. 8A-8F the amplitude of the coefficient is shown on a grayscale, with each pixel indicating the coefficient value for a node at the corresponding traveltime and spatial position. FIG. 8A indicates values of the coefficient A, FIG. 8B indicates values of the coefficient B. FIG. 8C indicates values of the coefficient C. FIG. 8D indicates values of the coefficient D. and FIG. 8E indicates values of the coefficient E. In each of FIGS. 8A-8E the reduced amount of noise, visible as a “speckled” appearance, in the lower panels in comparison to the upper panels, indicate that erroneous outlier values of the respective coefficients have been eliminated or at least reduced.

FIG. 8F shows a plurality of traveltime operators represented as wavefronts or arrival times. As mentioned, the upper panels show traveltime operators input into the workflow and the lower panels outputs. In contrast to FIGS. 8A-8E, each sub-panel, such as sub-panel 802 in FIG. 8F shows a plurality of traveltimes described by traveltime operators of a plurality of nodes at a single spatial location but a plurality of temporal locations. Of note, whereas the traveltime operators in the input panels exhibits dips (“moveouts”) exhibit both positive (increasing to the right) and negative (increasing to the left) those in the output panels largely exhibit only one or the other.

FIG. 9 shows a flowchart (900), in accordance with one or more embodiments. In Step 902, a seismic acquisition system, a seismic dataset pertaining to a subterranean region of interest may be obtained. The seismic dataset includes a plurality of samples in a plurality of dimensions. In some embodiments, the plurality of dimensions may include four space dimensions and a time dimension. For example, the four space dimensions may include two orthogonal dimensions in a horizontal plane describing the seismic source location and a further two orthogonal dimensions in a horizontal plane describing the seismic receiver location. In other embodiments, the plurality of dimensions may include only one, two, or three spatial dimensions. The plurality of gather forming the seismic dataset may be arranged in a variety of manner without limiting the scope of the invention. For example, in some embodiments the samples may be arranged in a common-source gather, in other embodiments the samples may be arranged in common-receiver gathers. In still other embodiments, the samples may be arranged in common-midpoint gathers. These examples of arrangements of the samples into gathers are provided for illustration only. Other arrangements, including other gathers know to a person of ordinary skill in the art may also be used without departing from the scope of the invention.

Steps 904-920 may be performed using a seismic processing system. In Step 904 a plurality of nodes, wherein each node of the plurality specifies a location in the plurality of dimensions and wherein each node has a plurality of neighboring nodes adjacent to it in the plurality of dimensions may be formed. Typically, a node is described by a moment in the time dimension and a position in one or more space dimensions.

Steps 906-908 may be performed for each node. In Step 906, a traveltime operator may be determined based on a portion of the seismic dataset within an aperture surrounding the node. The traveltime operator may include a quadratic function in one, two, or more space dimensions. These space dimensions may be mutually orthogonal. In some embodiments, determining the traveltime operator may be accomplished by finding an extremum, such as a maximum of a semblance operator. In other embodiments an extremum, such as a maximum, may be found for a coherence operator.

In Step 908, a canonical operator based on the traveltime operator may be assigned. A canonical operator may be a locus of points, arc or curve in space and time. For example, a canonical operator may be an arc with traveltimes at both opposing spatial extremes being larger than its traveltime at an intermediate point between the opposing spatial extremes. Another canonical operator may be an arc with traveltimes at both opposing spatial extremes being smaller than its traveltime at an intermediate point between the opposing spatial extremes. Still other canonical operators may have traveltimes that monotonically increase, or alternatively decrease, with a directional change in spatial location.

In Step 910, a plurality of windows may be formed. Each window of the plurality of windows may include a group of neighboring nodes. In particular, neighboring nodes may have similar spatial locations.

Each of Steps 912-918 may be performed for each of the plurality of windows formed in Step 910. In Step 912 a modal canonical operator may be determined for each window. The modal canonical operator may be based on the canonical operator for each neighboring node within the window and may be the most frequently occurring canonical operator within the window.

In Step 914, modal-nodes within the window may be determined. Modal nodes are nodes whose canonical operator is equal to modal canonical operator. Conversely, in Step 916 deviating-nodes within the window may be determined. Deviating-nodes are nodes whose canonical operator deviates from, or equivalently is not equal to the modal canonical operator. Each node within the window is determined to be either a modal-node or a deviating node.

Continuing with FIG. 9, in Step 918, a replacement traveltime operator may be determined for each deviating-node based on the traveltime operator of modal-nodes within the window. The replacement traveltime operator may be determined by performing convergent projection onto convex sets using the traveltime operator for at least a portion of the modal nodes within the window. In some embodiments performing convergent projection onto convex sets may include determining a frequency-wavenumber seismic dataset by transforming the seismic dataset from a time-space domain to the frequency-wavenumber domain. Further a frequency-wavenumber projected seismic dataset may be determined by applying a first projection onto convex sets to the frequency-wavenumber seismic dataset and determining a time-space domain projected seismic dataset by transforming the frequency-wavenumber projected seismic dataset back from the frequency-wavenumber domain to the time-space domain. Still further, projecting the time-space domain projected seismic dataset by applying a second projection onto convex sets to produce a replacement traveltime operator of each deviating-node.

In Step 920, a seismic image of the subterranean region of interest may be formed based on the seismic dataset and the traveltime operator of the modal-nodes and the replacement traveltime operator of the deviating-nodes. In some embodiments, the seismic image may be formed performing prestack migration, such as prestack time migration or prestack depth migration. In other embodiments, the seismic image may be formed performing post-stack migration, such as such as post-stack time migration or post-stack depth migration.

The resulting seismic image may be used to a drilling target. A seismic interpretation workstation may be used to facilitate the interpretation of the seismic image and geological structures, including hydrocarbon reservoirs manifested therein. The drilling target may be a localized position in the hydrocarbon reservoir or may be an extended arc running through the hydrocarbon reservoir or a portion thereof.

A wellbore trajectory may subsequently be planned guided, at least in part, by the drilling target. Other factors influencing the wellbore trajectory may include available surface locations from which to begin drilling and at which to position the wellhead. For example, existing wellsite on land, and particularly drilling rigs offshore may be strongly preferred over a new well site. The planned wellbore trajectory may be contained in the wellbore drilling plan (120) and the wellbore drilling plan may also specify the “weight” or density of drilling mud, and the casing weight and circumference to use and planned drilled depths at which drilling may pause, casing be inserted, worn or “dull” drill bits replaced, and wellbore caliper reduced.

The planned wellbore trajectory contained in the wellbore drilling plan (120) may then be transferred to a drilling system (900) such that the wellbore path (904) may be drilled as illustrated in FIG. 10 in accordance with one or more embodiments. Although the drilling system (900) is displayed as located on land, the drilling system (122) may also be a marine wellbore drilling system positioned on a jack-up rig, a floating rig, or a drill ship. As such, the illustrated drilling system (900) is not intended to limit the present disclosure.

FIG. 10 illustrates a drilling system 114 in accordance with one or more embodiments. A wellbore 1005 may be drilled, using the drilling system 114, guided by the planned wellbore path 1010 to penetrate the hydrocarbon reservoir 204. Although the drilling system 114 shown in FIG. 10 is used to drill the wellbore 1005 on land, the drilling system 114 may also be a marine wellbore drilling system. The example of the drilling system 114 shown in FIG. 10 is not meant to limit the present disclosure.

As shown in FIG. 10, the wellbore 1005 may be drilled using a drill rig that may be situated on a land drill site, an offshore platform, such as a jack-up rig, a semi-submersible, or a drill ship. The drill rig may be equipped with a hoisting system, such as a derrick 1015, which can raise or lower the drillstring 1020 and other tools required to drill the wellbore 1005. The drillstring 1020 may include one or more drill pipes connected to form conduit and a bottom hole assembly 1025 (BHA) disposed at the distal end of the drillstring 1020. The BHA 1025 may include a drill bit 1030 to cut into rock 1060, including cap rock 1060a. The BHA 1025 may further include measurement tools, such as a measurement-while-drilling (MWD) tool and logging-while-drilling (LWD) tool. MWD tools may include sensors and hardware to measure downhole drilling parameters, such as the azimuth and inclination of the drill bit 1030, the weight-on-bit, and the torque. The LWD measurements may include sensors, such as resistivity, gamma ray, and neutron density sensors, to characterize the rock 1060 surrounding the wellbore 1005. Both MWD and LWD measurements may be transmitted to the surface of the earth 216 using any suitable telemetry system known in the art, such as a mud-pulse or by wired-drill pipe.

To start drilling, or “spudding in,” the wellbore 1005, the hoisting system lowers the drillstring 1020 suspended from the derrick 1015 towards the planned surface location of the wellbore 1005. An engine, such as a diesel engine, may be used to supply power to the top drive 1035 to rotate the drillstring 1020 via the drive shaft 1040. The weight of the drillstring 1020 combined with the rotational motion enables the drill bit 1030 to bore the wellbore 1005.

The near-surface of the subterranean region of interest 202 is typically made up of loose or soft sediment or rock 1060, so large diameter casing 1045 (e.g., “base pipe” or “conductor casing”) is often put in place while drilling to stabilize and isolate the wellbore 1005. At the top of the base pipe is the wellhead, which serves to provide pressure control through a series of spools, valves, or adapters (not shown). Once near-surface drilling has begun, water or drill fluid may be used to force the base pipe into place using a pumping system until the wellhead is situated just above the surface of the earth 216.

Drilling may continue without any casing 1045 once deeper or more compact rock 1060 is reached. While drilling, a drilling mud system 1050 may pump drilling mud from a mud tank on the surface of the earth 216 through the drill pipe. Drilling mud serves various purposes, including pressure equalization, removal of rock cuttings, and drill bit cooling and lubrication.

At planned depth intervals, drilling may be paused and the drillstring 1020 withdrawn from the wellbore 1005. Sections of casing 1045 may be connected and inserted and cemented into the wellbore 1005. Casing string may be cemented in place by pumping cement and mud, separated by a “cementing plug,” from the surface of the earth 216 through the drill pipe. The cementing plug and drilling mud force the cement through the drill pipe and into the annular space between the casing 1045 and the wall of the wellbore 1005. Once the cement cures, drilling may recommence. The drilling process is often performed in several stages. Therefore, the drilling and casing cycle may be repeated more than once, depending on the depth of the wellbore 1005 and the pressure on the walls of the wellbore 1005 from surrounding rock 1060.

Due to the high pressures experienced by deep wellbores 1005, a blowout preventer (BOP) may be installed at the wellhead to protect the rig and environment from unplanned oil or gas releases. As the wellbore 1005 becomes deeper, both successively smaller drill bits 1030 and casing 1045 may be used. Drilling deviated or horizontal wellbores 1005 may require specialized drill bits 1030 or drill assemblies.

The drilling system 114 may be disposed at and communicate with other systems in the wellbore environment. The drilling system 114 may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target with the hydrocarbon reservoir 204 is reached or the presence of hydrocarbons is established.

In some embodiments the wellbore planning system (118), the seismic processing system (106), and the seismic interpretation workstation (110) may each include a computer system.

Embodiments may be implemented on a computer system. FIG. 11 is a block diagram of a computer system (1100) used to provide computational functionalities associated with described algorithms, methods, functions, processes, flows, and procedures as described in the instant disclosure, according to an implementation. The illustrated computer system (1100) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system (1100) may include a computer that includes an input device, such as a keypad, keyboard, touch screen, or other device that can accept user information, and an output device that conveys information associated with the operation of the computer system (1100), including digital data, visual, or audio information (or a combination of information), or a GUI.

The computer system (1100) can serve in a role as a client, network component, a server, a database or other persistency, or any other component (or a combination of roles) of a computer system for performing the subject matter described in the instant disclosure. The illustrated computer system (1100) is communicably coupled with a network (1102). In some implementations, one or more components of the computer system (1100) may be configured to operate within environments, including cloud-computing-based, local, global, or other environment (or a combination of environments).

At a high level, the computer system (1100) is an electronic computing device operable to receive, transmit, process, store, or manage data and information associated with the described subject matter. According to some implementations, the computer system (1100) may also include or be communicably coupled with an application server, e-mail server, web server, caching server, streaming data server, business intelligence (BI) server, or other server (or a combination of servers).

The computer system (1100) can receive requests over network (1102) from a client application (for example, executing on another computer system (1100)) and responding to the received requests by processing the said requests in an appropriate software application. In addition, requests may also be sent to the computer system (1100) from internal users (for example, from a command console or by other appropriate access method), external or third-parties, other automated applications, as well as any other appropriate entities, individuals, systems, or computers.

Each of the components of the computer system (1100) can communicate using a system bus (1104). In some implementations, any or all of the components of the computer system (1100), both hardware or software (or a combination of hardware and software), may interface with each other or the interface (1106) (or a combination of both) over the system bus (1104) using an application programming interface (API) (1108) or a service layer (1110) (or a combination of the API (1108) and service layer (1110). The API (1108) may include specifications for routines, data structures, and object classes. The API (1108) may be either computer-language independent or dependent and refer to a complete interface, a single function, or even a set of APIs. The service layer (1110) provides software services to the computer system (1100) or other components (whether or not illustrated) that are communicably coupled to the computer (1100). The functionality of the computer (1100) may be accessible for all service consumers using this service layer. Software services, such as those provided by the service layer (1110), provide reusable, defined business functionalities through a defined interface. For example, the interface may be software written in JAVA, C++, or other suitable language providing data in extensible markup language (XML) format or other suitable format. While illustrated as an integrated component of the computer (1100), alternative implementations may illustrate the API (1108) or the service layer (1110) as stand-alone components in relation to other components of the computer (1100) or other components (whether or not illustrated) that are communicably coupled to the computer (1100). Moreover, any or all parts of the API (1108) or the service layer (1110) may be implemented as child or sub-modules of another software module, enterprise application, or hardware module without departing from the scope of this disclosure.

The computer (1100) includes an interface (1106). Although illustrated as a single interface (1106) in FIG. 11, two or more interfaces (1106) may be used according to particular needs, desires, or particular implementations of the computer (1100). The interface (1106) is used by the computer (1100) for communicating with other systems in a distributed environment that are connected to the network (1102). Generally, the interface (1106) includes logic encoded in software or hardware (or a combination of software and hardware) and operable to communicate with the network (1102). More specifically, the interface (1106) may include software supporting one or more communication protocols associated with communications such that the network (1102) or interface's hardware is operable to communicate physical signals within and outside of the illustrated computer (1100).

The computer (1100) includes at least one computer processor (1112). Although illustrated as a single computer processor (1112) in FIG. 11, two or more processors may be used according to particular needs, desires, or particular implementations of the computer (1100). Generally, the computer processor (1112) executes instructions and manipulates data to perform the operations of the computer (1100) and any algorithms, methods, functions, processes, flows, and procedures as described in the instant disclosure.

The computer (1100) also includes a memory (1114) that holds data for the computer (1100) or other components (or a combination of both) that may be connected to the network (1102). For example, memory (1114) may be a database storing data consistent with this disclosure. Although illustrated as a single memory (1114) in FIG. 11, two or more memories may be used according to particular needs, desires, or particular implementations of the computer (1100) and the described functionality. While memory (1114) is illustrated as an integral component of the computer (1100), in alternative implementations, memory (1114) may be external to the computer (1100).

In addition to holding data, the memory may be a non-transitory medium storing computer readable instruction capable of execution by the computer processor (1112) and having the functionality for carrying out manipulation of the data including mathematical computations.

The application (1116) is an algorithmic software engine providing functionality according to particular needs, desires, or particular implementations of the computer (1100), particularly with respect to functionality described in this disclosure. For example, application (1116) can serve as one or more components, modules, applications, etc. Further, although illustrated as a single application (1116), the application (1116) may be implemented as multiple applications (1116) on the computer (1100). In addition, although illustrated as integral to the computer (1100), in alternative implementations, the application (1116) may be external to the computer (1100).

There may be any number of computers (1100) associated with, or external to, a computer system containing computer (1100), each computer (1100) communicating over network (1102). Further, the term “client,” “user,” and other appropriate terminology may be used interchangeably as appropriate without departing from the scope of this disclosure. Moreover, this disclosure contemplates that many users may use one computer (1100), or that one user may use multiple computers (1100).

In some embodiments, the computer (1100) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AlaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining, from a seismic acquisition system, a seismic dataset pertaining to a subterranean region of interest, wherein the seismic dataset comprises a plurality of samples in a plurality of dimensions;
using a seismic processing system:
forming a plurality of nodes, wherein each node of the plurality specifies a location in the plurality of dimensions and wherein each node has a plurality of neighboring nodes adjacent to it in the plurality of dimensions,
for each node:
determining, a traveltime operator, based on a portion of the seismic dataset within an aperture surrounding the node; and
assigning a canonical operator based on the traveltime operator,
forming a plurality of windows, wherein each window of the plurality of windows comprises a neighboring node;
for each window of the plurality of window:
determining a modal canonical operator, based on the canonical operator for each neighboring node within the window;
determining modal-nodes within the window, wherein the canonical operator of each modal-node is equal to modal canonical operator;
determining deviating-nodes within the window, wherein the canonical operator of each deviating-node deviates from the modal canonical operator; and
determining a replacement traveltime operator for each deviating-node based on the traveltime operator of modal-nodes within the window, and
forming a seismic image of the subterranean region of interest based on the seismic dataset and the traveltime operator of the modal-nodes within the plurality of nodes and the replacement traveltime operator of the deviating-nodes within the plurality of nodes.

2. The method of claim 1, further comprising:
identifying, using a seismic interpretation workstation, a drilling target based, at least in part, on the seismic image; and
planning, using a well planning system, a wellbore trajectory guided by the drilling target.

3. The method of claim 2, further comprising drilling, using a drilling system, a wellbore guided by the planned well trajectory.

4. The method of claim 1, wherein samples within the plurality of samples are arranged as common-midpoint gathers.

5. The method of claim 1, wherein determining a replacement traveltime operator comprises performing convergent projection onto convex sets.

6. The method of claim 5, wherein performing convergent projection onto convex sets comprises:
determining a frequency-wavenumber seismic dataset by transforming the seismic dataset from a time-space domain to the frequency-wavenumber domain;
determining a frequency-wavenumber projected seismic dataset by applying a first projection onto convex sets to the frequency-wavenumber seismic dataset;
determining a time-space domain projected seismic dataset by transforming the frequency-wavenumber projected seismic dataset from the frequency-wavenumber domain to the time-space domain; and
projecting the time-space domain projected seismic dataset by applying a second projection onto convex sets.

7. The method of claim 1, wherein the plurality of dimensions comprises four space dimensions and a time dimension.

8. The method of claim 1, wherein the traveltime operator comprises a quadratic function in two orthogonal space dimensions.

9. The method of claim 1, wherein determining the traveltime operator comprises finding an extremum of a semblance operator.

10. The method of claim 1, wherein forming the seismic image comprises performing prestack migration.

11. A system, comprising:
a seismic acquisition system, configured to obtain a seismic dataset pertaining to a subterranean region of interest, wherein the seismic dataset comprises a plurality of samples in a plurality of dimensions; and
a seismic processing system, configured to:
form a plurality of nodes, wherein each node of the plurality specifies a location in the plurality of dimensions and wherein each node has a plurality of neighboring nodes adjacent to it in the plurality of dimensions,
for each node:
determine, a traveltime operator, based on a portion of the seismic dataset within an aperture surrounding the node; and
assign a canonical operator based on the traveltime operator,
form a plurality of windows, wherein each window of the plurality of windows comprises a group of neighboring nodes;
for each window of the plurality of window:
determine a modal canonical operator, based on the canonical operator for each neighboring node within the window;
determine modal-nodes within the window, wherein the canonical operator of each modal-node is equal to modal canonical operator;
determine deviating-nodes within the window, wherein the canonical operator of each deviating-node deviates from the modal canonical operator; and
determine a replacement traveltime operator for each deviating-node based on the traveltime operator of modal-nodes within the window, and
form a seismic image of the subterranean region of interest based on the seismic dataset and the traveltime operator of the modal-nodes within the plurality of nodes and the replacement traveltime operator of the deviating-nodes within the plurality of nodes.

12. The system of claim 11, further comprising:
a seismic interpretation workstation, configured to identify a drilling target based, at least in part, on the seismic image; and
a well planning system, configured to plan a wellbore trajectory guided by the drilling target.

13. The system of claim 12, further comprising a drilling system, configured to drill a wellbore guided by the planned well trajectory.

14. The system of claim 11, wherein samples within the plurality of samples are arranged as common-midpoint gathers.

15. The system of claim 11, wherein determining a replacement traveltime operator comprises performing convergent projection onto convex sets.

16. The system of claim 15, wherein performing convergent projection onto convex sets comprises:
determining a frequency-wavenumber seismic dataset by transforming the seismic dataset from a time-space domain to the frequency-wavenumber domain;
determining a frequency-wavenumber projected seismic dataset by applying a first projection onto convex sets to the frequency-wavenumber seismic dataset;
determining a time-space domain projected seismic dataset by transforming the frequency-wavenumber projected seismic dataset from the frequency-wavenumber domain to the time-space domain; and
projecting the time-space domain projected seismic dataset by applying a second projection onto convex sets.

17. The system of claim 11, wherein the plurality of dimensions comprises four space dimensions and a time dimension.

18. The system of claim 11, wherein the traveltime operator comprises a quadratic function in two orthogonal space dimensions.

19. The system of claim 11, wherein determining the traveltime operator comprises finding an extremum of a semblance operator.

20. The system of claim 11, wherein forming the seismic image comprises performing prestack migration.
